(19) United States
(12) Patent Application Publication
(10) Pub. No.: US 2009/0116672 A1
(43) Pub. Date: May 7, 2009

(54) Instant custom ear mold with removable receiver insert for auditory devices

(76) Inventors: Dave Prahl, Andover, MN (US); Marc Musselman, Osseo, MN (US)

Correspondence Address: Jon David Schirado;Schirado Law Office, P.A., Suite 102, 6040 Main Street, Rockford, MN, 55373, US

(21) Appl. No.: 12/290,574

(22) Filed: Oct. 31, 2008

Related U.S. Application Data
(60) Provisional application No. 61/001,250, filed on Nov. 1, 2007.

(51) Int. Cl. H04R 25/00

(52) U.S. Cl. 381/329

(57) ABSTRACT

An instant custom ear mold with a removable receiver insert having threads on the insert and ear mold in a plurality of places. The instant custom ear mold with a removable receiver insert allows for the easy removal, cleaning, repair or replacement of the receiver and allows the same day fitting advantages of instant ear mold material.

### FIELD OF THE INVENTION

The present invention relates to auditory devices. In particular, this invention relates to an instant custom ear mold and a removable receiver insert for auditory devices, with the exclusion of hearing instruments as defined by the U.S. Food & Drug Administration.

### BACKGROUND OF THE INVENTION

Instant custom ear molds are becoming increasingly popular as an added option for auditory devices. An instant custom ear mold allows for same day fittings of ear molds specifically contoured to an individual's ear. Many instant custom ear molds are used with radio communication devices, swim molds, noise protectors and blue tooth devices.

The utilization of a removable receiver insert with an instant custom ear mold has not been adequately addressed. U.S. Pat. No. 7,139,404 provides a BTE/CIC auditory device and modular connector system. However, the device does not feature a removable receiver insert. Furthermore, the device is not made of an instant ear mold material.

U.S. Pat. Nos. 6,275,596; 6,009,183; and 5,381,484 provide ear molds and open fit devices of various designs. However, none of these patents provides an instant custom ear mold with a removable receiver insert.

### SUMMARY OF THE INVENTION

The disadvantages of the prior art may be overcome by providing an instant custom ear mold with a removable receiver insert that allows for the easy removal, cleaning, repair or replacement of the receiver and allows the same day fitting advantages of instant ear mold material. Still other advantages will be apparent from the disclosure that follows.

According to one aspect of the invention, there is provided an instant custom ear mold with a removable receiver insert that allows the easy removal of the receiver and receiver tube. Inside and outside the removable receiver insert are sets of threads that allow the retention of the insert within the instant custom ear mold as well as the easy removal.

### DESCRIPTION OF THE DRAWINGS

In drawings which illustrate embodiments of the present invention,

FIG. 1 is a side view of the instant custom ear mold with the removable receiver insert in the ear mold.

FIG. 2 is an exploded view of the removable receiver insert with the external flange removed.

FIG. 3 is an alternate embodiment of the instant ear mold with a removable cover in the ear mold.

### DESCRIPTION OF THE INVENTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

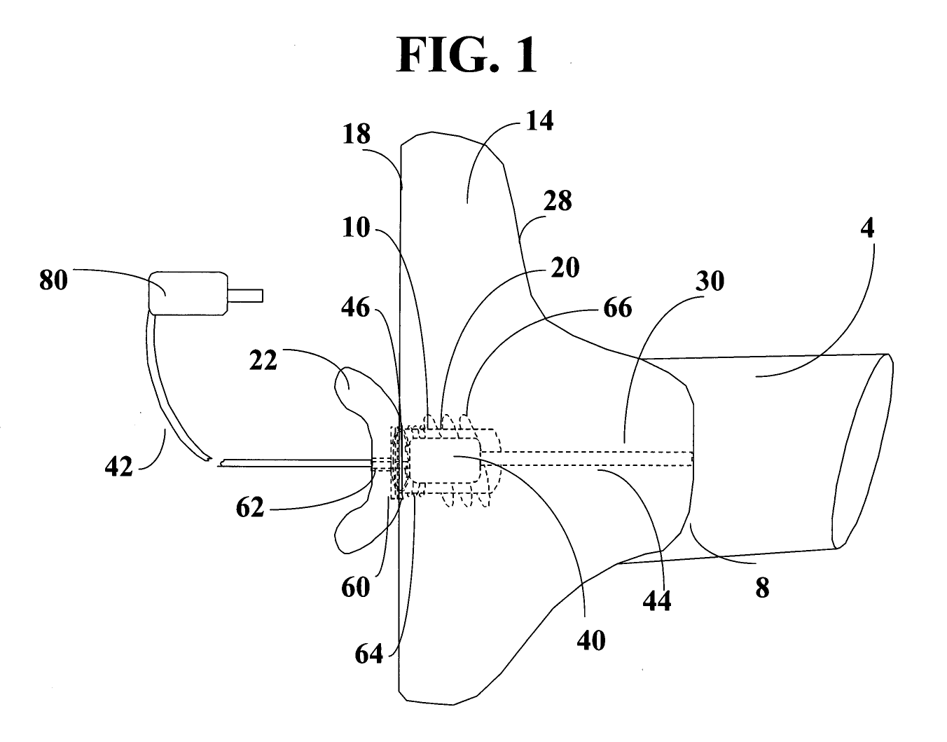

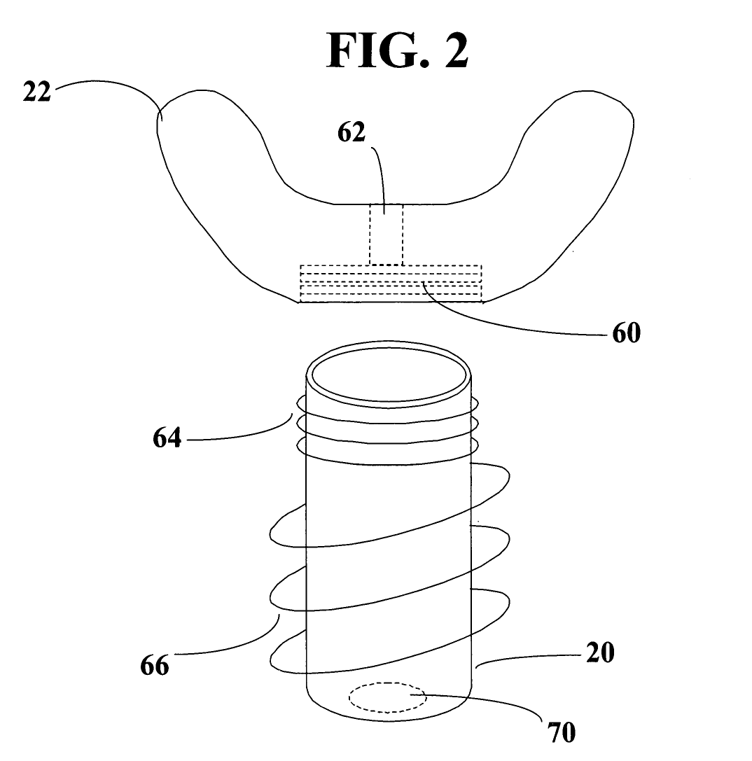

Referring to FIGS. 1-2, the present invention comprises an instant custom ear mold with a removable receiver insert. Referring to FIG. 1, the instant custom ear mold 14 with the removable receiver insert 10 of the present invention is generally illustrated. The instant custom ear mold is a flexible material that generally comprises a canal 8, a concha 18, and an orifice on the canal side 30 connected to a larger threaded orifice opposite the canal 28 on the concha side. The canal side 8 rests in the human ear canal 4. The removable receiver insert generally comprises a hollow threaded cylinder 20 and a removable external flange 22 that attaches to the cylinder. The threaded cylinder 20 is inserted into the concha side of the ear mold while the ear mold material is soft and is removed once the material is hardened to create the larger threaded orifice opposite the canal 28. Glue may also be used to secure the cylinder 20 within the larger threaded orifice 28. The removable external flange 22 has a large threaded orifice 60 connected to a smaller orifice 62. The cylinder 20 is inserted into the large threaded orifice 60 on the removable external flange 22. The receiver 40 is attached to receiver wire assembly 42 and a receiver tube 44. A knot 46 is tied in the receiver wire near the receiver to prevent the receiver from being pulled through the smaller orifice 62 in the removable external flange 22. The wires terminate in an audio jack 80. The length of the cylinder 20 is such that the receiver 40 is fully covered when inside the cylinder. The height of the receiver tube 44 is such that the receiver tube extends beyond the end of the tip of the canal 8 to allow for trimming flush to the canal. The cylinder 20 and external flange 22 can be made of any suitable material such as plastic. The receiver 40 is attached to the receiver wire assembly 42 by soldering methods which are well known in the art. The receiver 40 is attached to the receiver tube 44 by gluing methods which are well known in the art.

Referring to FIG. 2, the threaded cylinder 20 is secured to the removable external flange 22 by mating threads 60 and 64. The section of the threaded cylinder 20 on the concha side that fits within the external flange 22 is of a smaller diameter than the threaded orifice 60 in the removable external flange. The receiver rests against the bottom of the cylinder 20, and is secured within the cylinder by the small cylinder orifice 70 on the canal side which is smaller than the diameter of the receiver and the external flange 22 on the side opposite the canal. The receiver wire assembly has a smaller diameter than the small orifice on the removable external flange 22, allowing the wires to pass through the small orifice. The section of the threaded cylinder proximate to the canal side 66 allows the cylinder to be threaded into the larger threaded orifice of the instant custom ear mold.

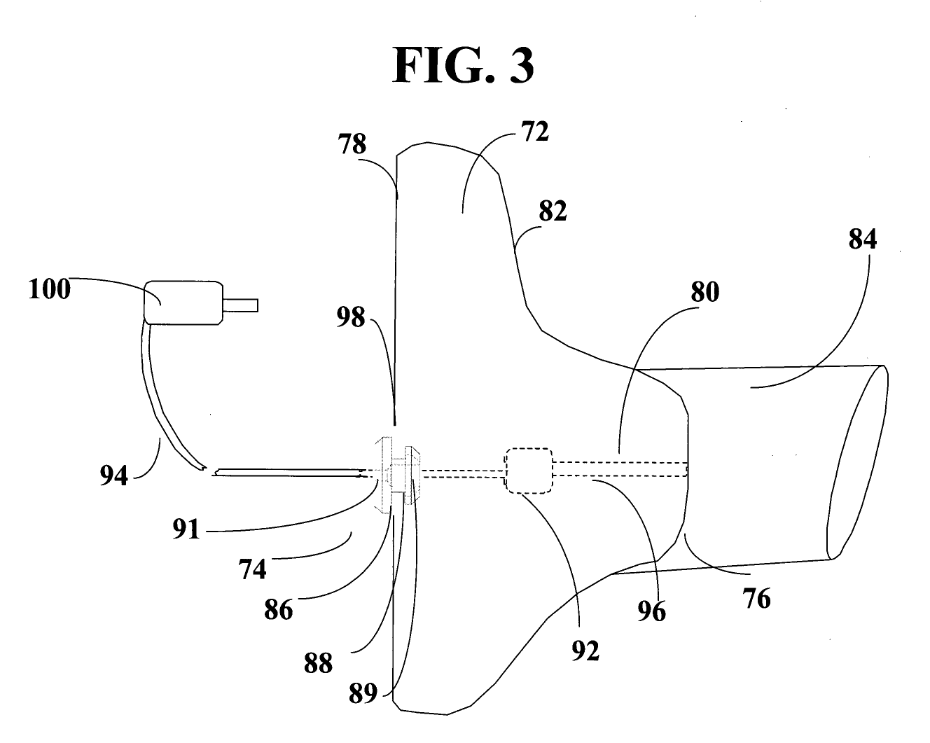

Referring to FIG. 3, an alternative embodiment comprising of the instant ear mold with a removable cover in the ear mold. The instant custom ear mold 72 with the removable cover 74 of the present invention is generally illustrated. The instant custom ear mold is a flexible material that generally comprises a canal 76, a concha 78, and an orifice on the canal side 80 connected to a larger orifice opposite the canal 82 on the concha side. The canal side 76 rests in the human ear canal 84. The removable cover generally comprises a cylinder 86 and a flange 88 with a larger orifice and a smaller orifice 91 through the center. The concha side of the ear mold has an orifice 90 with a diameter smaller than the diameter of the flange on the removable cover. The removable cover 74 is inserted into the orifice 90 on the concha side of the ear mold and retained by the flange 88. The receiver 92 is attached to receiver wire assembly 94 and a receiver tube 96. A knot 98 is tied in the receiver wire near the receiver to prevent the receiver from being pulled through the smaller orifice 89 in the removable cover 74. The wires terminate in an audio jack 100. The height of the receiver tube 96 is such that the receiver tube extends beyond the end of the tip of the canal 76 to allow for trimming flush to the canal. The removable cover 74 can be made of any suitable material such as plastic. The receiver 92 is attached to the receiver wire assembly 94 by soldering methods which are well known in the art. The receiver 92 is attached to the receiver tube 96 by gluing methods which are well known in the art.

In an alternative embodiment, the receiver tube orifice is created by attaching a wire to the otoblock. In an alternative embodiment, the receiver tube orifice is drilled through the instant custom ear mold. In an alternative embodiment, the removable receiver insert assembly is sold with an instant custom ear mold kit and glue. In an alternative embodiment, the removable external flange is snapped onto the cylinder.

In each of these embodiments the instant custom ear mold with removable receiver insert may further include numerous accessories commercially available. Multiple colors may be used for aesthetics.

The above described embodiments of the invention are intended to be an example of the present invention and alterations and modifications may be effected thereto, by those of skill in the art, without departing from the scope of the invention.

What is claimed is:

1. An instant custom ear mold with a removable receiver insert for auditory devices, with the exclusion of hearing instruments as defined by the U.S. Food & Drug Administration, comprising:
i.) an instant custom ear mold having a plurality of orifices;
ii.) a removable receiver insert having a plurality of orifices and a plurality of threads that extend through the orifices in the instant custom ear mold;
iii.) a receiver assembly that fits within the removable receiver assembly;
iv.) a removable external flange having a plurality of orifices.

2. The invention in claim 1 wherein the removable insert flange is shaped like a wing nut.

3. The invention in claim 1 wherein the orifice for the receiver tube is made by attaching a wire to the otoblock.

4. The invention in claim 1 wherein the orifice for the receiver tube is made by drilling through the instant custom ear mold material.

5. An instant custom ear mold with a removable receiver insert for auditory devices, with the exclusion of hearing instruments as defined by the U.S. Food & Drug Administration, comprising:
i.) an instant custom ear mold having a plurality of orifices;
ii.) a removable receiver cover having a plurality of orifices and a flange that is secured into an orifice in the instant custom ear mold; and
iii.) a receiver assembly that fits within the instant ear mold.

6. An instant custom ear mold and removable receiver insert kit for auditory devices, with the exclusion of hearing instruments as defined by the U.S. Food & Drug Administration, comprising:
i.) instant custom ear mold material;
ii.) removable receiver insert assembly;
iii.) glue;
iv.) instructions for utilizing the kit.
